(19) United States
(12) Patent Application Publication
(10) Pub. No.: US 2013/0063958 A1
(43) Pub. Date: Mar. 14, 2013

(54) LAMP HEAT DISSIPATING DEVICE, AND HEAT DISSIPATING ASSEMBLY THEREOF

(71) Applicant: Chin-Wen WANG, Pingzhen City (TW)

(72) Inventor: Chin-Wen WANG, Pingzhen City (TW)

(73) Assignees: LEADER TREND TECHNOLOGY CORP.; Chin-Wen Wang

(21) Appl. No.: 13/230,785

(22) Filed: Sep. 12, 2011

(51) Int. Cl. F21V 29/00; F28F 7/00

(52) U.S. Cl. 362/382; 165/185

(57) ABSTRACT

In a lamp heat dissipating device and a heat dissipating assembly mounted onto a lamp base, the heat dissipating device includes a heat conducting base, a U-shaped heat pipe, and a heat dissipating body. The heat conducting base includes a groove formed on a surface of the heat conducting base. The U-shaped heat pipe includes an evaporation section and two condensation sections, and the evaporation section is combined into a groove. The heat dissipating body includes a circular cylinder and a plurality of hollow heat dissipating cylinders. The circular cylinder includes two containing grooves provided for inserting two condensation sections respectively, and the heat dissipating cylinders are arranged into a circular shape with a gap from one another and installed on an external side of the circular cylinder to increase the heat conducting area and heat dissipating area so as to improve the heat dissipating efficiency.

### FIELD OF THE INVENTION

The present invention relates to a heat dissipating device, in particular to a lamp heat dissipating device of a heat pipe, and a heat dissipating assembly

### BACKGROUND OF THE INVENTION

Light emitting diode (LED) with the high-brightness, power-saving, and long-life advantages is applied extensively in various illumination lamps. However, the LED is a point light source, so that several LEDs are generally combined into an LED lamp module to improve the illumination range and brightness for its application.

Since the LED lamp generates a large amount of heat in its illumination, therefore most of the present LED lamps come with a heat dissipating device. Heat conducting components such as a heat conduction base, a heat pipe and a heat dissipating body are combined to form the heat dissipating device, and the heat dissipating device is mounted onto a lamp base for dissipating the heat produced during the operation of the LED lamp.

In the aforementioned structure, the heat dissipating body is generally composed of a plurality of heat dissipating fins, and the heat dissipating fins can increase the heat dissipating area to improve the heat dissipating speed. As the quantity of the LEDs increases and the technology of high power LEDs advances, the quantity of heat generated in the operation of the LED lamp becomes increasingly greater. Therefore, it is a motive for the inventor of the present invention to maximize the heat conducting and dissipating area within a specific space to improve the heat dissipating efficiency and meets the application requirements.

In view of the foregoing heat dissipation problem, the inventor of the present invention conducted extensive researches and experiments and finally provided a feasible design to overcome the aforementioned problem.

### SUMMARY OF THE INVENTION

Therefore, it is a primary objective of the present invention to provide a lamp heat dissipating device and a heat dissipating assembly to increase the heat conducting area and the heat dissipating area to improve the heat dissipating efficiency.

To achieve the foregoing objectives, the present invention provides a lamp heat dissipating device mounted onto a lamp base and comprising a heat conducting base, a U-shaped heat pipe, and a heat dissipating body, wherein the heat conducting base includes a groove formed on a surface of the heat conducting base. The U-shaped heat pipe includes an evaporation section and two condensation sections, and the evaporation section is combined into the groove. The heat dissipating body comprises a circular cylinder and a plurality of hollow heat dissipating cylinders, and the circular cylinder includes two containing grooves for passing and installing two condensation sections, and the heat dissipating cylinders are arranged circularly with a gap from one another and installed on an external side of the circular cylinder.

To achieve the foregoing objective, the present invention provides a heat dissipating assembly for passing and installing a U-shaped heat pipe having two condensation sections, and the heat dissipating assembly comprises: a circular cylinder, being a hollow cylinder, and having two corresponding heat dissipating channels, two containing grooves for passing and installing the two condensation sections, and a fish-bone shaped support plate formed inside the circular cylinder, and the circular cylinder being coupled integrally by connecting the support plate; a plurality of hollow heat dissipating cylinders, arranged circularly with a gap from one another and installed on an external side of the circular cylinder; a plurality of external heat dissipating fins, formed on an outer peripheral surface of the circular cylinder and extended outwardly from the outer peripheral surface of the circular cylinder; and a plurality of internal heat dissipating fins, formed on an internal wall of the circular cylinder, and extended inwardly from the internal wall of the circular cylinder.

Another objective of the present invention is to provide a lamp heat dissipating device and a heat dissipating assembly thereof, wherein both of the circular cylinder and the heat dissipating cylinder have a slotted groove or a breach for facilitating the flow of air, so as to improve the heat dissipating effect.

Compared with the prior art, the lamp heat dissipating device and the heat dissipating body of the heat dissipating assembly in accordance with the present invention comprises a circular cylinder and a plurality of hollow heat dissipating cylinders, and the heat dissipating cylinders are arranged circularly with a gap from one another and installed on an external side of the circular cylinder. Since the heat dissipating body includes a fish-bone shaped support plate, a plurality of external heat dissipating fins, internal heat dissipating fins and auxiliary heat dissipating fins, the area of the heat dissipating body can be increased to achieve the effect of maximizing the heat conducting area and the heat dissipating area within a specific space, so as to conduct and dissipate the heat of the heat dissipating body, and improve the heat dissipating efficiency. In addition, both of the circular cylinder and the heat dissipating cylinder of the present invention have the slotted groove or breach to facilitate the flow of air, so as to improve the practicality of the present invention.

### BRIEF DESCRIPTION OF THE DRAWINGS

FIG. 1 is an exploded view of a lamp heat dissipating device and a heat dissipating assembly in accordance with the present invention;

FIG. 2 is a first cross-sectional view of a lamp heat dissipating device and a heat dissipating assembly in accordance with the present invention;

FIG. 3 is a second cross-sectional view of a lamp heat dissipating device and a heat dissipating assembly in accordance with the present invention;

FIG. 4 is a perspective view of a heat dissipating body in accordance with the present invention;

FIG. 5 is a cross-sectional view of a heat dissipating body in accordance with the present invention; and

FIG. 6 is a cross-sectional view of a heat dissipating body in accordance with another embodiment of the present invention.

### DESCRIPTION OF THE PREFERRED EMBODIMENTS

The technical characteristics and contents of the present invention will become apparent with the following detailed description and related drawings. The drawings are provided for the purpose of illustrating the present invention only, but not intended for limiting the scope of the invention.

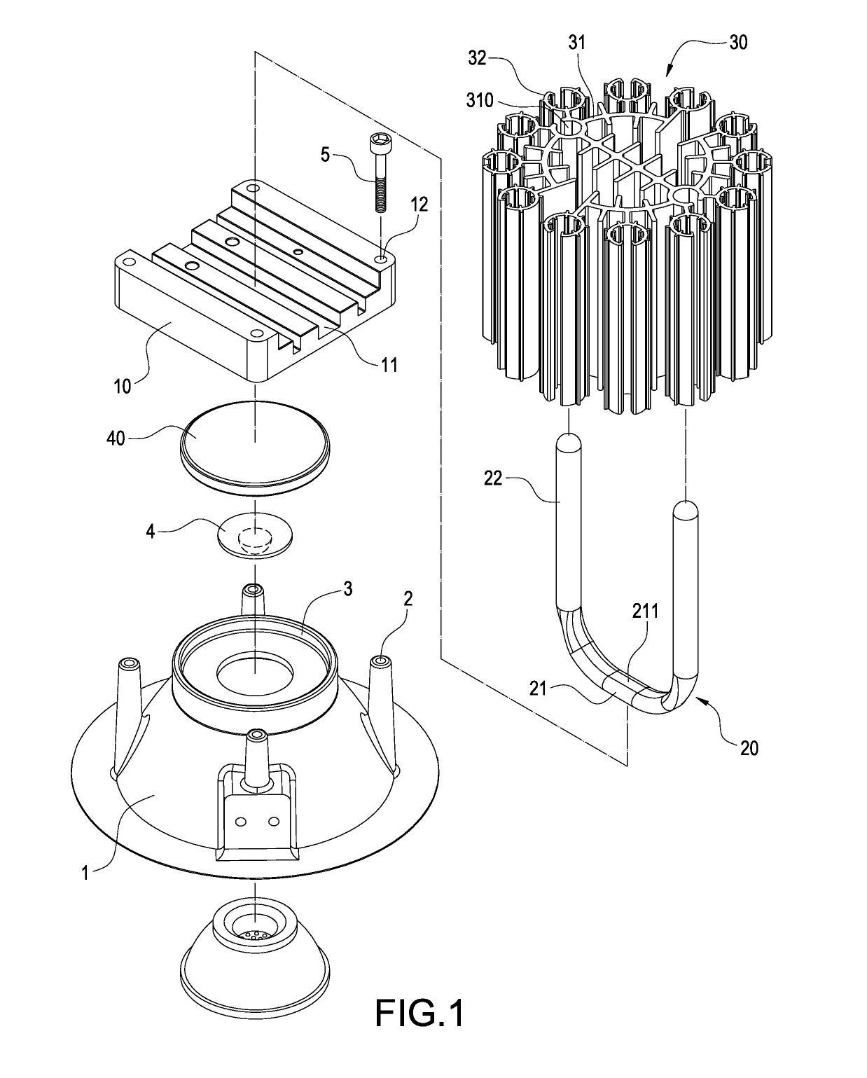

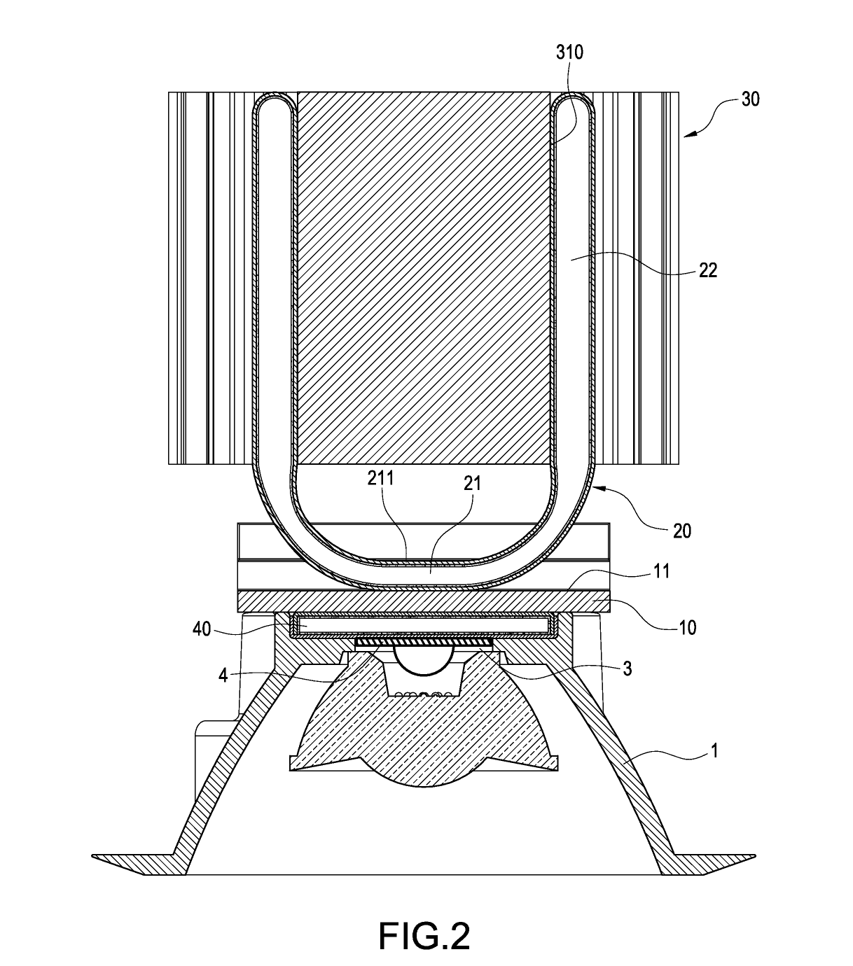

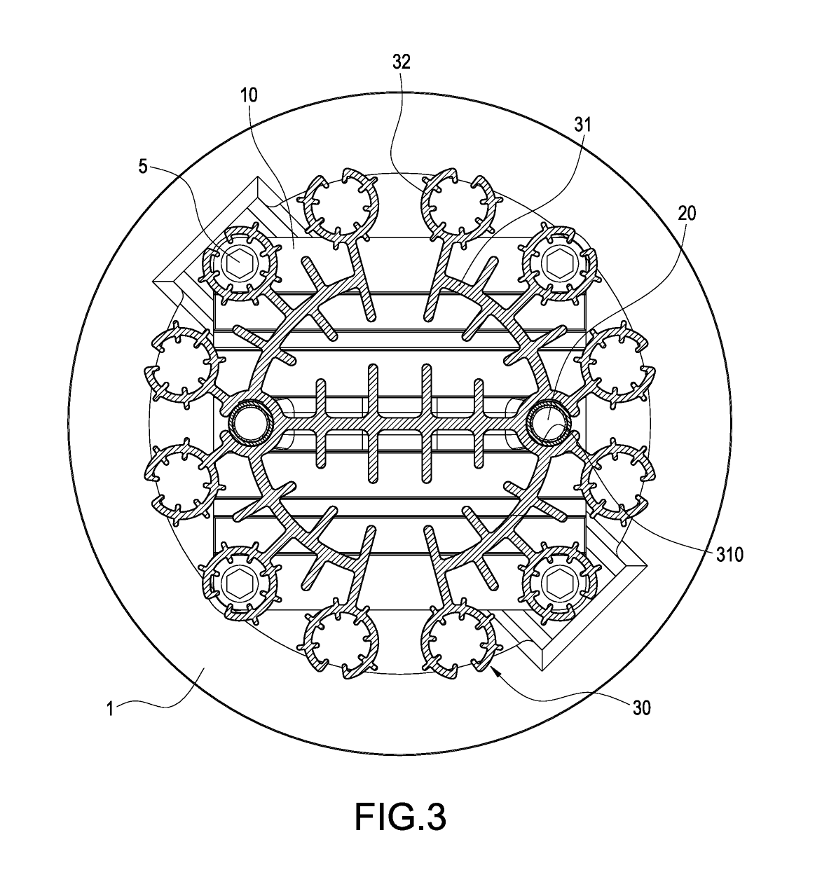

With reference to FIGS. 1 to 3 for an exploded view and cross-sectional views of a lamp heat dissipating device and a heat dissipating assembly in accordance with the present invention respectively, the lamp heat dissipating device and the heat dissipating assembly are mounted onto a lamp base 1 of a lamp, and the heat dissipating device comprises a heat conducting base 10, a U-shaped heat pipe 20, and a heat dissipating body 30.

The lamp base 1 has a plurality of locking holes 2, and the lamp base 1 has a containing space 3 and an LED module 4 installed in the containing space 3.

The heat conducting base 10 is made of a conductive material, and the heat conducting base 10 has a groove 11 formed on a surface of the heat conducting base 10, and a plurality of combining holes 12 corresponding to the locking holes 2 of the lamp base 1, and the heat conducting base 10 is secured to the lamp base 1 by a plurality of locking elements 5.

The U-shaped heat pipe 20 includes an evaporation section 21 and two condensation sections 22, and the evaporation section 21 is combined into the groove 11 and has a flat surface 211.

The heat dissipating body 30 includes a circular cylinder 31 and a plurality of hollow heat dissipating cylinders 32, and the circular cylinder 31 has two containing grooves 310 for passing and installing the two corresponding condensation sections 22, and the heat dissipating cylinders 32 are arranged circularly with a gap from one another, and installed on an external side of the circular cylinder 31.

In addition, the heat dissipating device further comprises a vapor chamber 40 installed in the containing space 3 of the lamp base 1 and clamped between the heat conducting base 10 and the LED module 4.

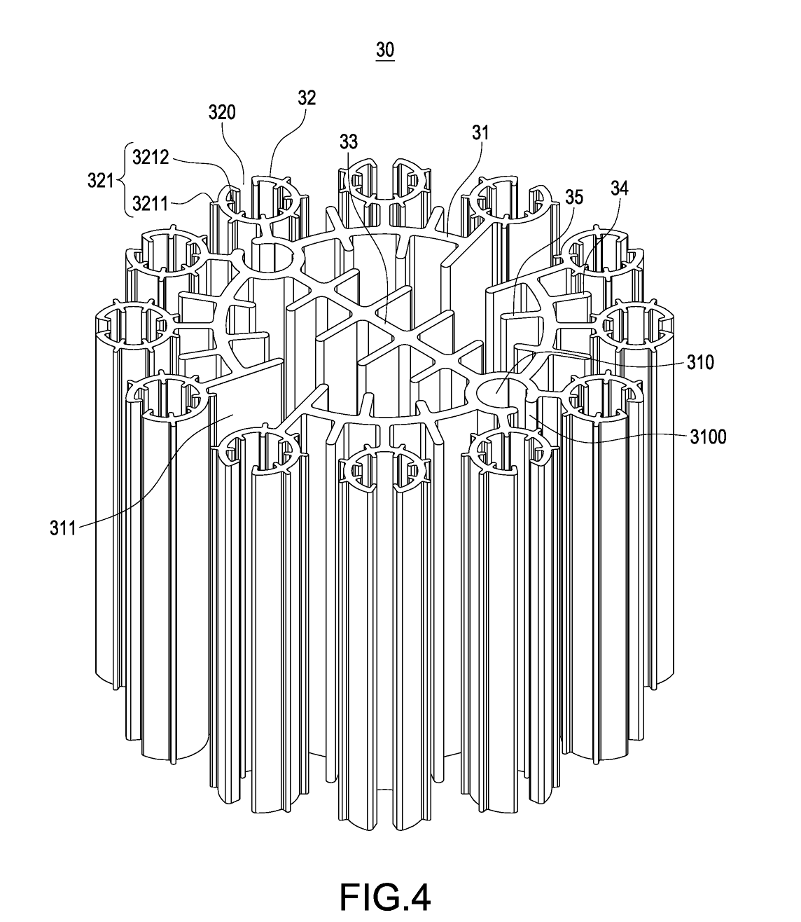

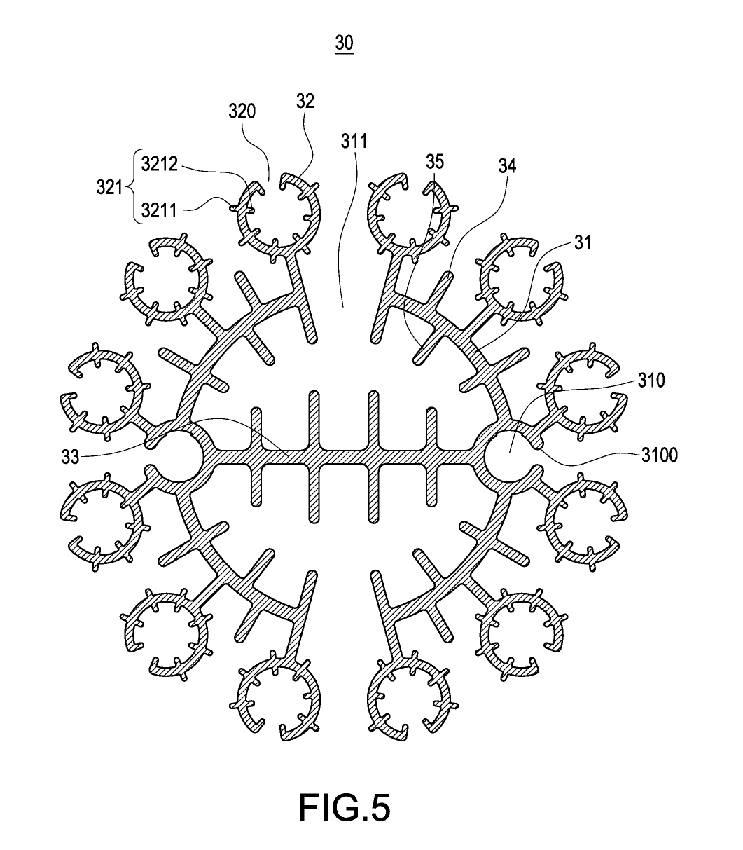

With reference to FIGS. 4 and 5 for a perspective view and a cross-sectional view of a heat dissipating body in accordance with the present invention respectively, the circular cylinder 31 of this preferred embodiment is a hollow cylinder having two corresponding heat dissipating channels 311. In addition, the heat dissipating body 30 includes a fish-bone shaped support plate 33 formed inside the circular cylinder 31, and the circular cylinder 31 is integrally combined as a whole by connecting the support plate 33. The two containing grooves 310 are disposed on both sides of the support plate 31 respectively, and the containing groove 310 has a substantially C-shaped cross-section and a breach 3100 with an opening formed towards the outside. The heat dissipating cylinder 32 has a substantially C-shaped cross-section and the heat dissipating cylinder 32 has slotted groove 320 arranged towards the outside.

The heat dissipating body 30 further comprises a plurality of external heat dissipating fins 34 and internal heat dissipating fins 35, and the external heat dissipating fins 34 are formed on an outer peripheral surface of the circular cylinder 31, and extended outwardly from the outer peripheral surface, and the internal heat dissipating fins 35 are formed on an internal wall 32 of the circular cylinder 31 and extended inwardly from the internal wall 32. In addition, some of the external heat dissipating fins 34 are coupled to the heat dissipating cylinders 32, and the heat dissipating cylinders 32 are coupled to ends of the external heat dissipating fins 34 respectively.

In this preferred embodiment, the heat dissipating cylinder 32 includes a plurality of auxiliary heat dissipating fins 321, and the auxiliary heat dissipating fins 321 include a plurality of auxiliary external heat dissipating fins 3211 and auxiliary internal heat dissipating fins 3212, and the auxiliary external heat dissipating fins 3211 are formed on an outer peripheral surface of the heat dissipating cylinder 32, and extended outwardly from the outer peripheral surface, and the auxiliary internal heat dissipating fins 3212 are formed on an internal wall of the heat dissipating cylinder 32 and extended from the internal wall. The installation of the heat dissipating cylinder 32, the fish-bone shaped support plate 33, the external heat dissipating fin 34, the internal heat dissipating fin 35 and the auxiliary heat dissipating fin 321 can be used for increasing the heat dissipating area of the heat dissipating body 30 to improve the heat dissipating efficiency.

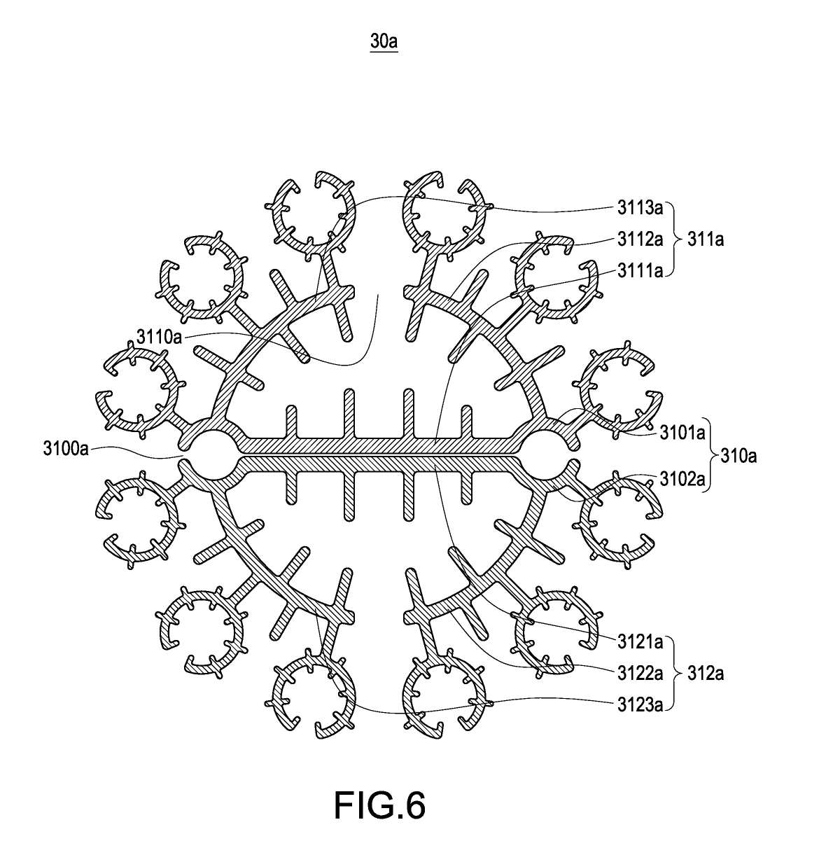

With reference to FIG. 6 for another preferred embodiment of a heat dissipating body of the present invention, the heat dissipating body 30a comprises a circular cylinder 31a and a plurality of hollow heat dissipating cylinders 32a, and the circular cylinder 31a includes two containing grooves 310a, and the heat dissipating cylinders 32a are arranged circularly with a gap from one another and installed on an external side of the circular cylinder 31a.

The difference between this preferred embodiment and the first preferred embodiment resides on that the circular cylinder 31a of this preferred embodiment is comprised of two hollow semicircular cylinders 311a, 312a, and each hollow semicircular cylinder 311a comprises a support plate 3111a and two arc plates 3112a, 3113a coupled to the support plate 3111a, and the two arc plates 3112a, 3113a are extended from both ends of the support plate 3111a respectively and in directions approaching each other, and a gap 3110a is maintained between the two arc plates 3112a, 3113a. Similarly, another hollow semicircular cylinder 312a comprises a support plate 3121a and two arc plates 3122a, 3123a coupled with the support plate 3121a. Wherein, the two support plates 3111a, 3121a of the two hollow semicircular cylinders 311a, 312a are attached to one another

In addition, the two containing grooves 310a are formed on both lateral sides of the support plate 3111a, 3121a respectively, and the containing groove 310a is comprised of two corresponding semicircular plates 3101a, 3102a and has a substantially C-shaped cross-section, and the containing groove 310a includes a breach with an opening formed towards the outside 3100a. It is noteworthy to point out that other structures are the same as those of the first preferred embodiment, and thus they are not repeated here.

While the invention has been described by means of specific embodiments, numerous modifications and variations could be made thereto by those skilled in the art without departing from the scope and spirit of the invention set forth in the claims.

What is claimed is:

1. A lamp heat dissipating device, mounted onto a lamp base of a lamp, comprising:
a heat conducting base, having a groove formed on a surface of the heat conducting base;
a U-shaped heat pipe, including an evaporation section and two condensation sections, and the evaporation section being combined into the groove; and
a heat dissipating body, including a circular cylinder and a plurality of hollow heat dissipating cylinders, and the circular cylinder having two containing grooves for passing and installing the two condensation sections, and the heat dissipating cylinders being arranged circularly with a gap between one another and installed on an external side of the circular cylinder.

2. The lamp heat dissipating device of claim 1, wherein the lamp base includes a plurality of locking holes, and the heat conducting base includes a plurality of combining holes, and the heat conducting base is secured onto the lamp base by the plurality of locking elements.

3. The lamp heat dissipating device of claim 1, wherein the evaporation section has a flat surface.

4. The lamp heat dissipating device of claim 1, wherein the circular cylinder is a hollow cylinder having two corresponding heat dissipating channels.

5. The lamp heat dissipating device of claim 1, wherein the heat dissipating body includes a fish-bone shaped support plate formed inside the circular cylinder, and the circular cylinder is integrally coupled as a whole by connecting the support plate.

6. The lamp heat dissipating device of claim 1, wherein the circular cylinder is comprised of two hollow semicircular cylinders, and each hollow semicircular cylinder includes a support plate and two arc plates coupled to the support plate, and two support plates of the two hollow semicircular cylinders are attached with each other.

7. The lamp heat dissipating device of claim 6, wherein the two arc plates are extended from both ends of the support plate respectively in directions towards each other, and a gap is maintained between the two arc plates.

8. The lamp heat dissipating device of claim 6, wherein the containing groove is comprised of two corresponding semicircular plates, and the two containing grooves are formed on both lateral sides of the support plate respectively.

9. The lamp heat dissipating device of claim 1, wherein the containing groove has a substantially C-shaped cross-section, and the containing groove has a breach with an opening formed towards the outside, and the heat dissipating cylinder has a substantially C-shaped cross-section, and the heat dissipating cylinder has a slotted groove arranged towards the outside.

10. The lamp heat dissipating device of claim 1, wherein the heat dissipating body further includes a plurality of external heat dissipating fins formed on an outer peripheral surface of the circular cylinder and extended outwardly from the outer peripheral surface of the circular cylinder.

11. The lamp heat dissipating device of claim 1, wherein the heat dissipating body further includes a plurality of internal heat dissipating fins formed on an internal wall of the circular cylinder and extended inwardly from the internal wall of the circular cylinder.

12. The lamp heat dissipating device of claim 10, wherein some of the external heat dissipating fins are coupled to the heat dissipating cylinders, and the heat dissipating cylinders are coupled to ends of the external heat dissipating fins respectively.

13. The lamp heat dissipating device of claim 1, wherein each heat dissipating cylinder includes a plurality of auxiliary heat dissipating fins, and some of the auxiliary heat dissipating fins are formed on an outer peripheral surface of the heat dissipating cylinder and extended outwardly from the outer peripheral surface of the heat dissipating cylinder, and some of the auxiliary heat dissipating fins are formed on an internal wall of the heat dissipating cylinder and extended inwardly the internal wall of the heat dissipating cylinder.

14. The lamp heat dissipating device of claim 1, wherein the lamp base includes a containing groove and an LED module installed in the containing groove, and the heat dissipating device further includes a vapor chamber installed in the containing groove and clamped between the heat conducting base and the LED module.

15. A heat dissipating assembly, for passing and installing a U-shaped heat pipe having two condensation sections, and the heat dissipating assembly comprising:
a circular cylinder, being a hollow cylinder, and having two corresponding heat dissipating channels, two containing grooves for passing and installing the two condensation sections, and a fish-bone shaped support plate formed inside the circular cylinder, and the circular cylinder being coupled integrally by connecting the fish-bone shaped support plate;
a plurality of hollow heat dissipating cylinders, arranged circularly with a gap from one another and installed on an external side of the circular cylinder;
a plurality of external heat dissipating fins, formed on an outer peripheral surface of the circular cylinder and extended outwardly from the outer peripheral surface of the circular cylinder; and
a plurality of internal heat dissipating fins, formed on an internal wall of the circular cylinder, and extended inwardly from the internal wall of the circular cylinder.

16. The heat dissipating assembly of claim 15, wherein the circular cylinder is comprised of two hollow semicircular cylinders, and each hollow semicircular cylinder includes a support plate and two arc plates coupled to the support plate, and two support plates of the two hollow semicircular cylinders are attached to each other.

17. The heat dissipating assembly of claim 16, wherein the two arc plates are extended from both ends of the support plate in directions approaching each other, and a gap is maintained between the two arc plates, and the containing groove is comprised of two corresponding semicircular plates, and the two containing grooves are formed on both lateral sides of the support plate respectively.

18. The heat dissipating assembly of claim 16, wherein the containing groove has a substantially C-shaped cross-section, and the containing groove has a breach with an opening formed towards the outside, and the heat dissipating cylinder has a substantially C-shaped cross-section, and the heat dissipating cylinder has a slotted groove arranged towards the outside.

19. The heat dissipating assembly of claim 18, wherein some of the external heat dissipating fins are coupled to the heat dissipating cylinders, and the heat dissipating cylinders are coupled to ends of the external heat dissipating fins respectively.

20. The heat dissipating assembly of claim 15, wherein each heat dissipating cylinder includes a plurality of auxiliary heat dissipating fins, and some of the auxiliary heat dissipating fins are formed on an outer peripheral surface of the heat dissipating cylinder and extended outwardly from the outer peripheral surface of the heat dissipating cylinder, and some of the auxiliary heat dissipating fins are formed on an internal wall of the heat dissipating cylinder and extended from the internal wall of the heat dissipating cylinder.
